(19) United States
(12) Patent Application Publication
(10) Pub. No.: US 2013/0304574 A1
(43) Pub. Date: Nov. 14, 2013

(54) INTELLIGENT ELECTRONIC INFORMATION DEPLOYMENT

(71) Applicants: Scott W. THOMAS, Youngsville, LA (US); Daniel L. HODGES, Youngsville, LA (US)

(72) Inventors: Scott W. THOMAS, Youngsville, LA (US); Daniel L. HODGES, Youngsville, LA (US)

(21) Appl. No.: 13/774,973

(22) Filed: Feb. 22, 2013

Related U.S. Application Data
(63) Continuation-in-part of application No. 13/106,684, filed on May 12, 2011.
(60) Provisional application No. 61/602,005, filed on Feb. 22, 2012.

(51) Int. Cl. G06Q 30/02

(52) U.S. Cl. CPC G06Q 30/0269
USPC 705/14.53; 705/14.66

(57) ABSTRACT

An intelligent content deployment system (ICDS) is described that enables content filtering and delivery based on a variety of factors, known or assumed, about one or more targeted subscribers (“Members”) of a content delivery network (“Network”) and delivers targeted information and content to distribution points in the vicinity of the members. The ICDS comprises an infrastructure for the collection and communication of member information or data, the processing of the information, and the intelligent delivery of content targeted to particular members and/or groups of members based on the collected member information. The ICDS infrastructure of an embodiment includes one or more of satellite-based, web-based, cellular-based electric/satellite linked and driven communication or network infrastructure for the collection of member information and the distribution of the targeted information to the members. The members receive the targeted information in their current setting, regardless of whether they are mobile or stationary.

### RELATED APPLICATION

This application claims the benefit of U.S. Patent Application No. 61/602,005, filed Feb. 22, 2012.

This application is a continuation in part of U.S. patent application Ser. No. 13/106,684, filed May 12, 2011.

### TECHNICAL FIELD

Embodiments are described relating to systems and methods for electronic information deployment and, more particularly, targeted electronic information deployment.

### BACKGROUND

In daily life, individuals are regularly bombarded with information that is aimed at the general public or some fraction of the public as a target audience that may or may not include the recipient individual. This leads to ineffective dissemination of information and ultimately has led the public to generally ignore much of the content that they encounter on a daily basis. Consequently there is a need to provide a better information targeting or delivery system and therefore a better and more meaningful experience to its members.

### INCORPORATION BY REFERENCE

Each patent, patent application, and/or publication mentioned in this specification is herein incorporated by reference in its entirety to the same extent as if each individual patent, patent application, and/or publication was specifically and individually indicated to be incorporated by reference.

### BRIEF DESCRIPTION OF THE DRAWINGS

FIG. 1 is a block diagram showing input parameters or factors received by the ICDS and used by the ICDS algorithms to generate targeted outputs, under an embodiment.

FIG. 2 is a block diagram of a scenario in which a single input is provided to the ICDS, under an embodiment.

FIG. 3 is a block diagram of a scenario in which the ICDS generates a single targeted output from a single input, under an embodiment.

FIG. 4 is a block diagram of a scenario in which the ICDS generates a single targeted output from multiple inputs of multiple members, under an embodiment.

FIG. 5 is a block diagram of a scenario in which multiple inputs are provided to the ICDS, which generates a single output/display, under an embodiment.

FIG. 6 is a block diagram of a scenario in which multiple inputs are provided to the ICDS for use in controlling multiple outputs/displays, under an embodiment.

FIG. 7 is a block diagram of a scenario in which multiple inputs are provided to the ICDS, which generates multiple outputs/displays, under an embodiment.

FIG. 8 is a block diagram of a scenario in which multiple inputs are provided to the ICDS, which generates multiple outputs/displays in a single, contained environment, under an embodiment.

### DETAILED DESCRIPTION

Systems and methods for intelligent content deployment are described herein, and are collectively referred to as the intelligent content deployment system (ICDS). Embodiments of the ICDS enable content filtering and delivery based on a variety of factors, known or assumed, about one or more targeted subscribers (“Members”) of a content delivery network (“Network”) and, in so doing, provide a superior means of reaching a particular individual or group of individuals with targeted information and content. The ICDS of an embodiment comprises an infrastructure for the collection and communication of member information or data, the processing of the information, and the intelligent delivery of content targeted to particular members and/or groups of members based on the collected member information. The ICDS infrastructure of an embodiment includes one or more of satellite-based, web-based, cellular-based electric/satellite linked and driven communication or network infrastructure for the collection of member information and the distribution of the targeted information to the members. The members receive the targeted information in their current setting, regardless of whether they are mobile (e.g., automobile, aircraft, boat, walking, etc.) or stationary (e.g., movie theater, sporting event, elevator ride, drive thru, pharmacy drive thru, restaurant drive thru, etc.). The members of an embodiment include one or more of individuals, groups, and regional and global consumers. The ICDS can be used in any one or combination of venues including, but not limited to, marketing venues, retail/wholesale business venues, including real-time supply chains (up and down), advertising venues, consumer preference venues, business- or transaction-based data exchanges.

The ICDS processes the member information that is collected using one or more intelligent content algorithms or programs running on one or more processor-based devices (e.g., servers, etc.), which select or determine the content to be delivered to one or more electronic media outlets at a given location and time. The ICDS algorithms, in processing the member information, consider one or more factors, wherein the factors comprise date, time, location, rate of speed, gender, age, expressed or implied interests, known or assumed travel itineraries, language, holidays (e.g., national, international, religious, personal (e.g., birthdays, anniversaries, etc.)), number of members in a given geographic area, emergency factors (e.g., traffic accident, weather situation, terrorist attack, etc.). The algorithms use cumulative past input (e.g., stored in memory) in possible combination with ongoing real-time global tracking data of individuals and groups to generate predictable behavior patterns that are used to help the group or individual make better informed computer-assisted (ongoing and future) decisions based on real-time global data collection (divergent and convergent).

The ICDS considers a wide variety of variables when determining what content to deliver, and intelligently determines what is to be delivered, to whom it is to be delivered, when it is to be delivered, where it is to be delivered, and prioritizes the order of what is delivered. In contrast to billboard-based advertising which has historically been a shotgun approach to targeting a subset of people that pass it in a given time period, the ICDS enables a highly-focused approach based on the particular individual(s) passing the media delivery outlet at any given moment. The ICDS also considers time in automatically determining the content to be displayed. Time can include time of day, day of week, season, holidays, etc. Over time, the system will have the ability to become more intelligent and better able to determine what content to deliver to whom, when and where.

By targeting Members with relevant content, the ICDS offers a custom experience for its Members and allows deliverers of content to precisely target those Members they are interested in reaching. Furthermore, the ICDS allows those parties delivering content to know exactly who was targeted, when, and how often. By offering an opportunity for feedback (e.g., via cell phone texting, touch screen media, etc.) the ICDS enables Members to interact and provide their input or response to a given bit of content. This can be used for test marketing, polling, volume planning, and many other applications. The ICDS enables the transformation of most media sources from a one-directional, broad based content delivery mechanism to a bi-directional, targeted, customized and adaptive network.

The ICDS of an embodiment, as described above, receives and processes a variety of specific information about targeted individuals or groups, and controls the output and destination of targeted content or information to the individuals or groups based on results of the real-time analysis. The ICDS of an embodiment includes an ICDS platform comprising one or more processor-based devices coupled to at least one database, and the ICDS platform processes the input information and outputs the processed information including targeted information and a destination for the targeted information. The ICDS platform includes and/or interfaces or integrates with numerous components including, but not limited to, a receiver that receives input information from a variety of input sources, a communication network over which the input information is received and the output information is transferred to the destination, and destination or distribution devices or systems where it is presented. Further description of the components of the ICDS follows below.

The input sources of an embodiment include cellular phones, personal digital assistants (PDAs), SIM cards, a registration/profile website, cable/satellite/fiber optic receivers, airline and travel websites or accounts (e.g. linked to an aa.com account), financial institutions (e.g., bank/credit card purchasing history), businesses (e.g., cash and/or credit purchasing history of consumers, businesses, government entities, etc.). The input sources also include stationary and non-stationary implantable devices of organic and non-organic materials (i.e. footwear, articles of clothing, personal transport devices, wheelchairs, scooters, vehicles, automobiles, airplanes, homes, buildings). The input sources also include any and all interne technology platforms, cellular technology platforms, network technology platforms, satellite-based platforms including atmospheric based refractory network systems. Additional input sources include automated transaction machines, including monetary and/or mass data exchange devices, systems and networks. The distribution points coupled to the ICDS and used for delivery of content include electronic billboards, cellular phones, PDAs, televisions, Digital Video Recorders, media kiosks (e.g., airport, café, shopping center, subway, pharmacy, etc.), electronic display devices in/on vehicles (e.g., automobiles, airplanes, trains, boats), shopping carts, media poles, casinos (e.g., slot machines, displays, etc.), automatic transaction machines, and pedestrian crossroads (e.g., Piccadilly Circle, London, Times Square, Grand Central Station NY, N.Y., Red Square, Moscow Russia, Venice Beach, Calif., etc.).

The communication networks used for collection of input information from the input sources and distribution of output information to distribution points include any combination of wired communication technologies, wireless technologies, cable platforms, cellular platforms, satellite platforms, network technologies, fiber optic platforms, and atmospheric-based refractory networks.

The ICDS delivers content to a targeted individual or group of individuals based on multi-dimensional combinations of inputs and decision factors. The inputs and decision factors include interests indicated through a Member's account/profile (e.g., buying habits; time of day; day of week; important upcoming dates (birthdays, anniversaries, holidays); actions taken today (e.g. have they eaten, have they been driving for several hours and likely to need fuel soon, etc.)). All information input into the account is historical preference information. Using the additional real-time information corresponding to the member and received into the ICDS, preference driven information is generated and delivered in real time to the member via the distribution points coupled to the ICDS. The content targeting of an embodiment also provides cumulative time-derived progressive intelligence on each end user, and this assists and adds to the individual's (or group of individuals') ability to select and make present and/or future choices based on predictable global informational trends relevant and tagged to each and every targeted individual.

The ICDS algorithms of an embodiment determine, based on the situation and content delivery mechanism (e.g., billboard, airport kiosk, monitor in automobile, etc.), the most appropriate content to deliver to member during any given period of time. Content specifically targets an individual or some fraction of the individuals who are within viewing range of the media device at that moment

As an example, if four of ten motorists who pass a given multimedia billboard in the next thirty seconds have an expressed interest in Harley Davidson motorcycles, the ICDS can determine this to be the most common denominator among that group and present an advertisement that targets that interest.

As another example, if four of ten motorists who pass a given multimedia billboard in the next thirty seconds have an expressed interest in Harley Davidson motorcycles, the ICDS can determine this is the most common denominator among that group. Taking into account that it is 7:30 AM and that Harley Davidson has determined that the most effective time to advertise to its target audience is from noon to midnight, the system can choose and present content that targets the group's next most common denominator. The algorithms can weigh factors and determine what is most appropriate to display based on one or more factors including, but not limited to, numbers of targets, time, speed, location, proximity to some other point or venue, and other extenuating factors.

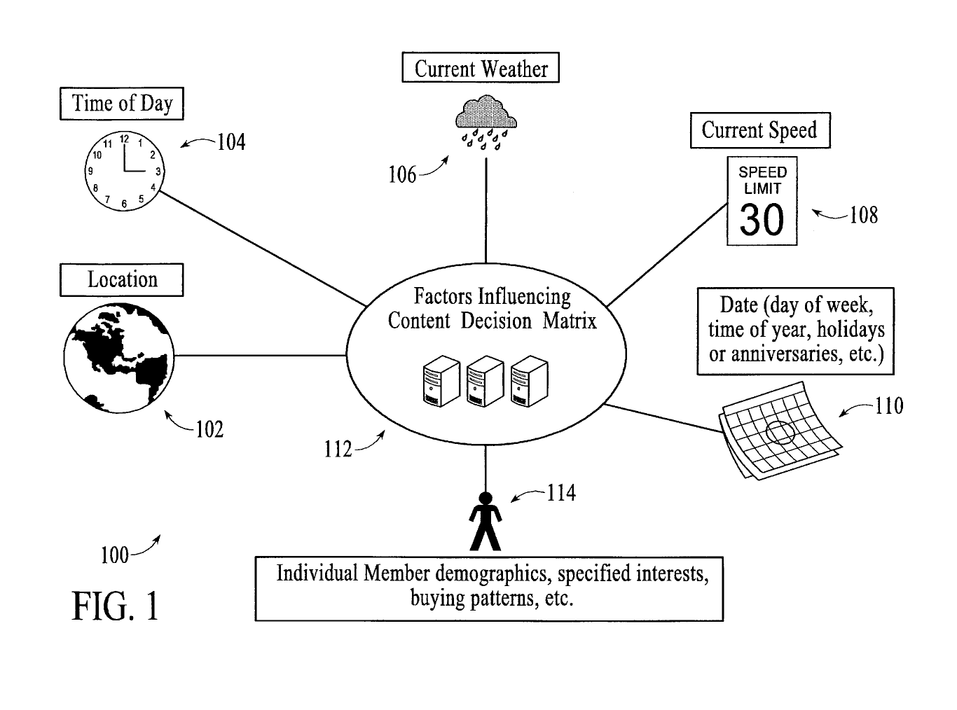

FIG. 1 is a block diagram showing input parameters or factors 102-112 received by the ICDS and used by the ICDS algorithms to generate targeted outputs, under an embodiment. As described above, the inputs include historical information 114, as input by a member into an account (e.g., demographic information, interests, spending patterns, etc.). The inputs also include current information 102-112 and can be received from any number/type/combination of sources (e.g., location, date, time, weather, current activity, movement information, etc.).

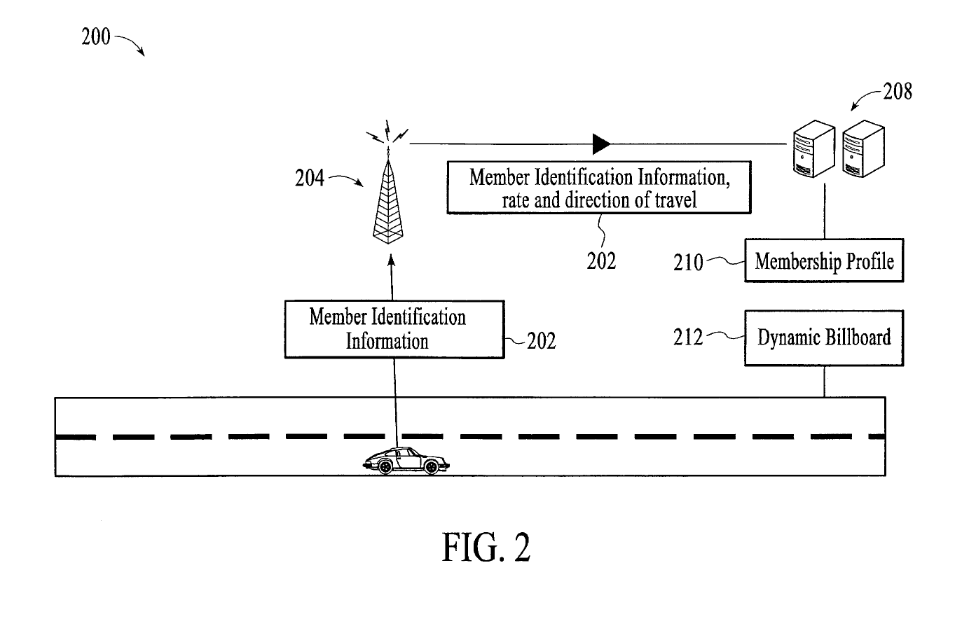

FIG. 2 is a block diagram of a scenario in which a single input 202 is provided to the ICDS, under an embodiment. The input 202 includes member information comprising current information received from any number/type/combination of sources (e.g., location, date, time, weather, current activity, movement information, rate of travel, direction of travel, route of travel, etc.). The member information is transferred to the ICDS 208 via cellular, satellite, and/or other communication mediums or networks 204, where it is analyzed along with the account/profile information, but is not so limited. The ICDS 208 uses the member information 202 and account/profile information 210 to generate targeted output that is used as input to one or more distribution points as further described below.

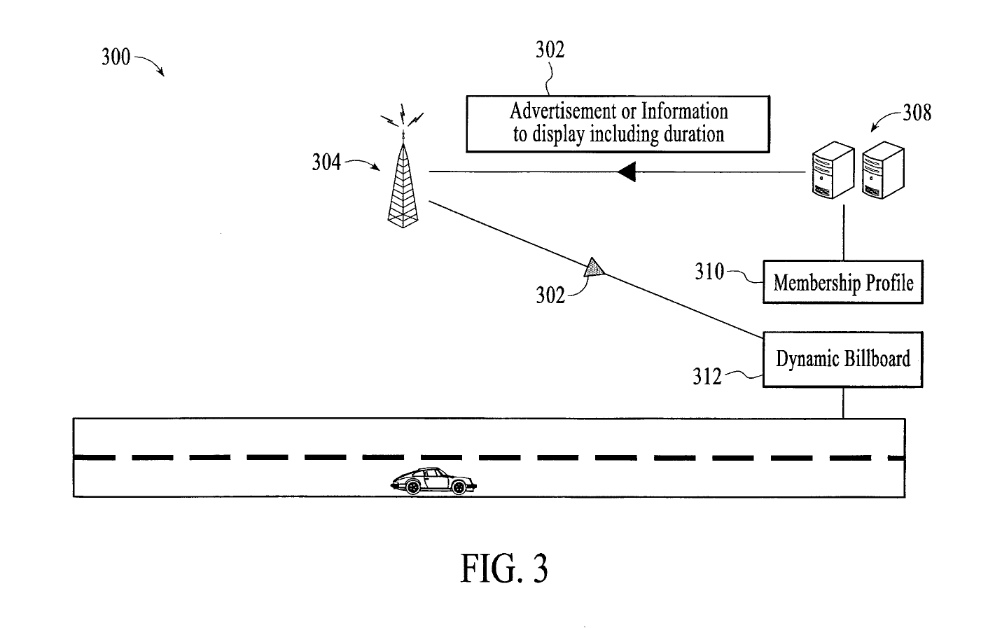

FIG. 3 is a block diagram of a scenario in which the ICDS 308 generates a single targeted output 302 from a single input, under an embodiment. The input 202 includes the member information comprising current information received from any number/type/combination of sources (e.g., location, date, time, weather, current activity, movement information, rate of travel, direction of travel, route of travel, etc.), as described herein. The member information is transferred to the ICDS 308 via cellular, satellite, and/or other communication mediums or networks 304, where it is analyzed along with the account/profile information 310, but is not so limited. The targeted output 302 of the analysis includes content transferred by the ICDS 308 to one or more distribution points 312 using a communication network 304. The output corresponds to the member and is transferred to the distribution point(s) at a time that corresponds approximately to the time the member is in viewing proximity to the distribution point.

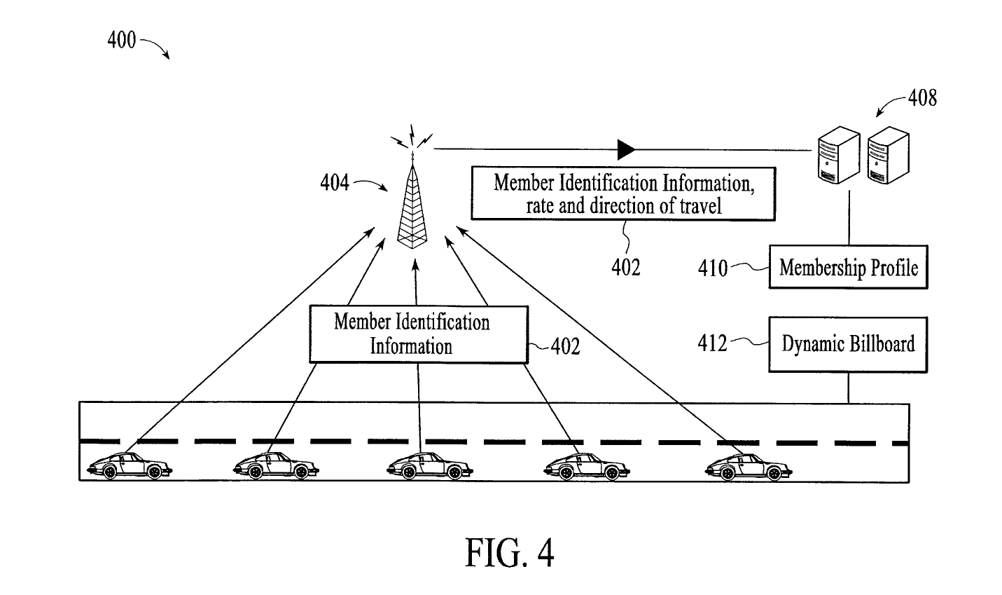

FIG. 4 is a block diagram of a scenario in which the ICDS 408 generates a single targeted output from multiple inputs 402 of multiple members, under an embodiment. The inputs include, for each member, member information 402 comprising current information received from any number/type/combination of sources (e.g., location, date, time, weather, current activity, movement information, rate of travel, direction of travel, route of travel, etc.), as described herein. The member information corresponding to each member is transferred to the ICDS 408 via cellular, satellite, and/or other communication mediums or networks 404, where it is analyzed along with the account/profile information 410 of each corresponding member, but is not so limited. The targeted output of the analysis includes content transferred by the ICDS 408 to one or more distribution points using a communication network as further described below. The output is determined by the ICDS 408 as that corresponding to the members (e.g., corresponding to a majority of the member interests, content for each member depending on timing and spacing relative to the dynamic billboard, etc.) and is transferred to the distribution point(s) 412 at a time that corresponds approximately to the time the member is in viewing proximity to the distribution point.

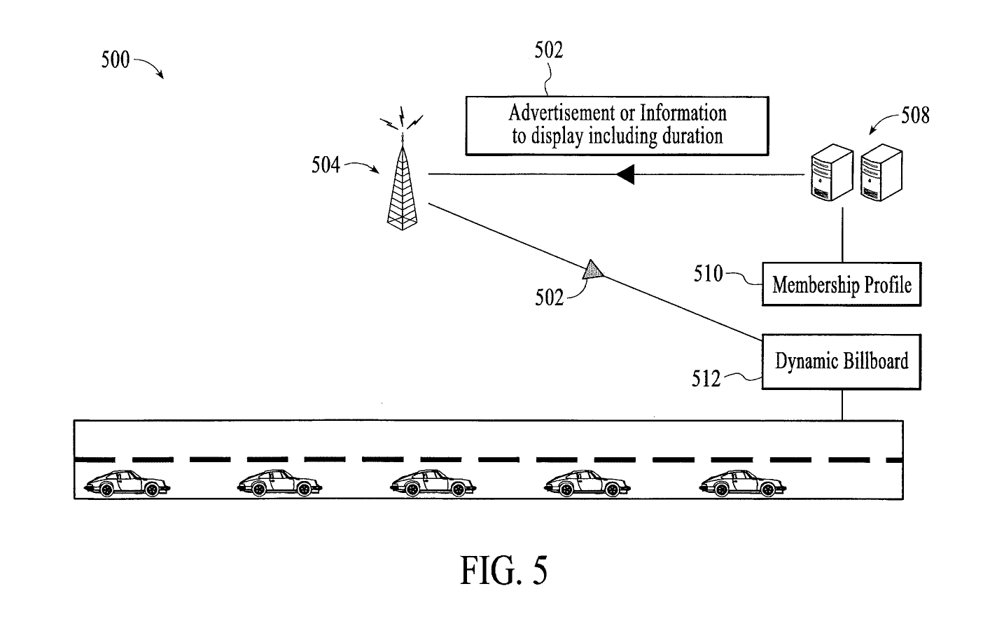

FIG. 5 is a block diagram of a scenario in which multiple inputs are provided to the ICDS 508, which generates a single output/display 502, under an embodiment. The input includes member information 402 comprising current information received from any number/type/combination of sources (e.g., location, date, time, weather, current activity, movement information, rate of travel, direction of travel, route of travel, etc.). The ICDS 508 uses the member information 402 and account/profile information 510 to generate targeted output that is targeted to a subset of individuals (e.g., two of the five vehicles passing the billboard) in the vicinity of the destination distribution point. In this example, the billboard content 502, 512 changes to target the occupants of one or more specific vehicles in a larger group of vehicles that pass the billboard during a given time period. The targeted content 502 generated by the ICDS 508 for presentation is based on the member information of the specific targeted members. Thus, the billboard content 502, 512 constantly changes to target specific members or groups of members viewing it during a particular time period. The ICDS 508 transfers the output to one or more distribution points (e.g., dynamic billboard 512) via cellular, satellite, and/or other communication mediums or networks 504, but is not so limited.

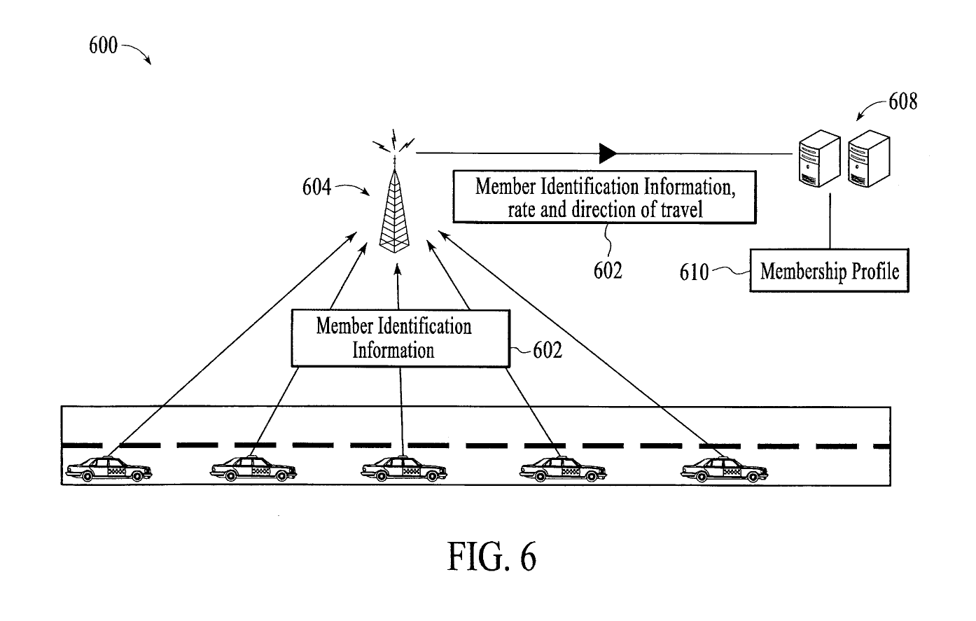

FIG. 6 is a block diagram of a scenario in which multiple inputs are provided to the ICDS 608 for use in controlling multiple outputs/displays, under an embodiment. The inputs include, for each member of a group of members, member information 602 comprising current information received from any number/type/combination of sources (e.g., location, date, time, weather, current activity, movement information, rate of travel, direction of travel, route of travel, etc.), as described herein. The member information 602 corresponding to each member is transferred to the ICDS 608 via cellular, satellite, and/or other communication mediums or networks 604, where it is analyzed along with the account/profile information 610 of each corresponding member, but is not so limited. The ICDS 608 uses the member information 602 and account/profile information 610 of each corresponding member to generate targeted output that is targeted to each member (e.g., the occupants of five vehicles). The ICDS transfers the output to the distribution points (e.g., dynamic billboard) in the vehicles via cellular, satellite, and/or other communication mediums or networks, but is not so limited.

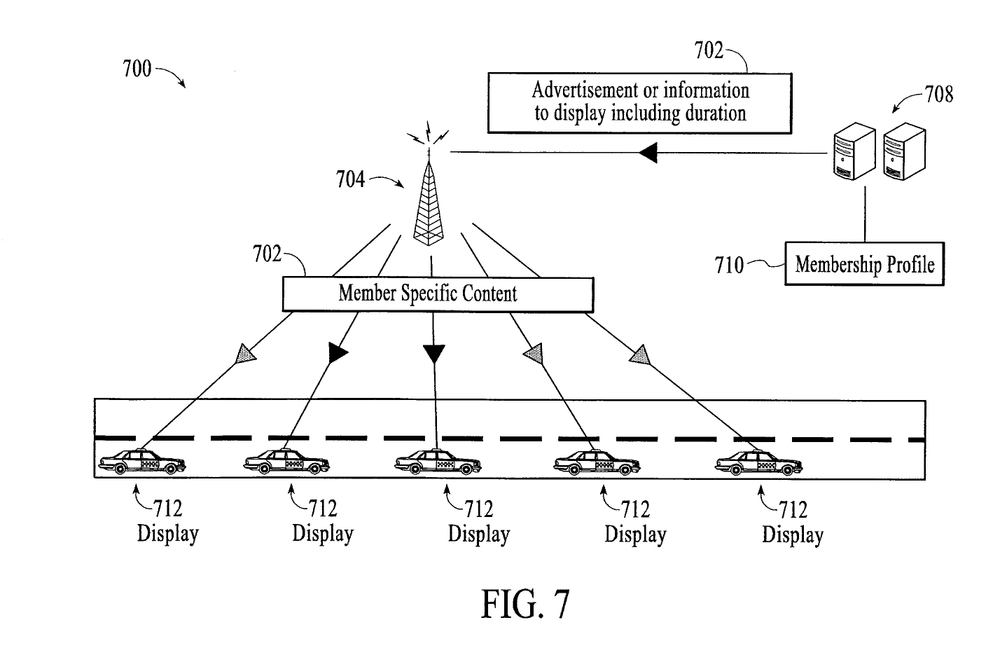

FIG. 7 is a block diagram of a scenario in which multiple inputs are provided to the ICDS, which generates multiple outputs/displays 702, under an embodiment. The inputs include, for each member, member information 602 comprising current information received from any number/type/combination of sources (e.g., location, date, time, weather, current activity, movement information, rate of travel, direction of travel, route of travel, etc.), as described herein. The member information 602 corresponding to each member is transferred to the ICDS 708 via cellular, satellite, and/or other communication mediums or networks 704, where it is analyzed along with the account/profile 710 information of each corresponding member, but is not so limited. The ICDS 708 uses the member information 602 and account/profile information 710 of each corresponding member to generate targeted output 702 that is targeted to each member (e.g., the occupants of five vehicles) and presented via a display 712 hosted in the vehicle in which the member is riding. In this example, the content presented to each member in each of the five vehicles is targeted to that member. The targeted content generated by the ICDS 708 for presentation to a member is based on the member information of that specific targeted member. The ICDS transfers the output to the distribution points (in-vehicle displays 712) via cellular, satellite, and/or other communication mediums or networks 704, but is not so limited.

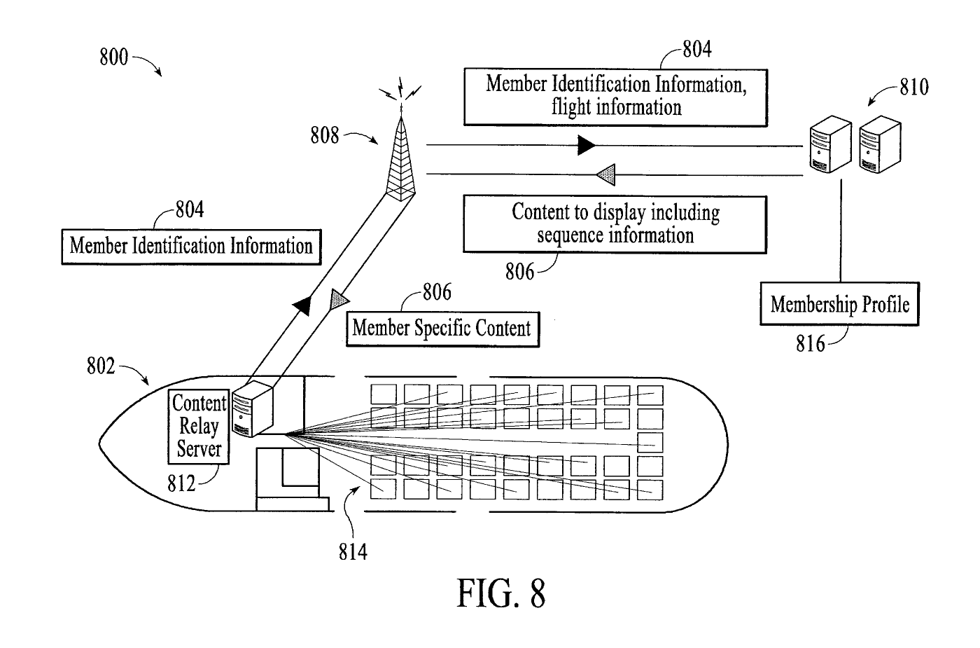

FIG. 8 is a block diagram of a scenario in which multiple inputs 804 are provided to the ICDS 810, which generates multiple outputs/displays 806 in a single, contained environment, under an embodiment. In this example the contained environment is an airliner passenger compartment 802, but is not so limited. The inputs include, for each member, member information 804 comprising current information received from any number/type/combination of sources (e.g., location, date, time, weather, current activity, movement information, rate of travel, direction of travel, route of travel, etc.), as described herein. The member information 804 corresponding to each member is transferred to the ICDS 810 via cellular, satellite, and/or other communication mediums or networks 808 prior to the aircraft 802 departing the terminal. The ICDS 810 analyses the member information 804 along with the account/profile information 816 of each corresponding member, but is not so limited. The ICDS 810 uses the member information 804 and account/profile information 816 of each corresponding member to generate targeted output 806 that is targeted to each member (e.g., the occupants of aircraft) and presented via a seatback display 814 positioned for viewing by the member. In this example, the content presented to each member in each aircraft seat is targeted to that member. The targeted content 806 generated by the ICDS 810 for presentation to a member is based on the member information 804 of that specific targeted member. The ICDS transfers the output to the distribution points (e.g., seatback displays 814) via a direct transfer to the display or through an on-board server or relay 812, but is not so limited.

The following example of the ICDS describes initial member registration with the system and subsequent processing and use of registration information to deliver targeted content to the member. In this example, a married male resident of Houston, Tex. named John Doe, age 45, subscribes as a Member of the network. During the registration process, John Doe provides personal data and information as follows.

John Doe provides the network with information regarding his spouse, dependents, occupational data and recreational preferences. John Doe has two dependents, one son and one daughter. John Doe's son and daughter celebrate birthdays on Sep. 18, 2004 and Feb. 5, 2001, respectively. John Doe is a healthcare sales professional and travels frequently for work. Aside from occupational activity, John Doe maintains a high level of interest in motorcycles (primarily the Harley Davidson franchise), golfing and recreational travel to gambling destinations such as Las Vegas. John Doe further maintains a strong interest in cycling, recreational travel to tropical destinations, sport fishing and NFL Football (primarily Houston Texans). John Doe maintains a moderate interest in scuba diving, wines (with particular interest in California Red wines and particular affinity for Cakebread Cellars product), and watercraft (pleasure boating).

John Doe additionally provides the network with information regarding memberships and/or associations. John Doe is a member or otherwise associated with each of the following: Continental One Pass, Marriott Rewards, and Avis President's Club. John Doe discloses these associations together with membership or account numbers.

John Doe also registers vehicle data with the network. John Doe owns a 2009 BMW 545i and 2008 Chevrolet Suburban. In addition to make and model, John additionally provides vehicle identification number, servicing dealer and automobile insurance carrier for each vehicle.

The ICDS algorithms process and store John's Doe membership data, continuously update the data and match membership data with John Doe's real time activities in order to present marketing content specific to John Doe's current environment, activity and emotional state. In an example, John Doe boards a plane in Houston heading to Phoenix, Ariz. The ICDS anticipates John's presence on this flight by drawing information from his Continental One Pass account. The Network is additionally aware of John's reservation in the downtown Marriott for a two night stay and of John's airline booking for a return flight to Houston on the return leg of his trip. When John boards the Phoenix bound plane, the ICDS confirms John's position on the aircraft by identifying any last minute changes in seating assignments (e.g. upgrade to first class). Based on his seating location, the Network identifies the on flight screen located in the back of the headrest facing John's position. At this point the Network uses the display to provide downloaded or queued information that is relevant to John Doe's personal experiences and specific location (present and projected) in time (6:45 am Monday CST, May 12^{th}). The Network presents John information about the new year-model Harley Davidson Dyna Wide Glide with touchscreen options to click-through the presentation for further information and details regarding the Harley Davidson along with options to access similar or related product or merchandise information. The Network logs a history of John's response to the presented content. The log indicates John's response to touch-screen click-through options indicating content preferences, duration of the viewing session or failure to respond at all. The ICDS applications may then use logged preferences to tailor future content presentations and prevent duplicative material.

In addition to or as an alternative to the motorcycle presentation, the ICDS reminds John of his impending wedding anniversary. Using data cross-referenced from his wife's membership profile, John is given an option to preview anniversary gift items organized by type, expense, popularity or any other appropriate category. He selects a jewelry category and narrows his interest to Mikimoto pearls. John browses the collection, discovers a necklace of particular interest and clicks-through to identify product vendors. Given an option to research Houston or Phoenix vendors, John indicates a preference to shop in Phoenix and is accordingly presented with local Phoenix vendors. Upon selecting a vendor close to his hotel (based on recommendations provided by the ICDS application), the network notifies the vendor that John wishes to view the item during his two day trip in Phoenix. Based on this information, the vendor expects the visit and prepares the particular item for viewing.

Once the items of “high priority” described above are exhausted, the ICDS applications progress to content of general interest. As opposed to pre-selecting discrete presentations based on profile information, John is given the option to view material by general category including shopping, travel, education, news, professional, sports and technology. However, the ICDS still personalizes this browsing experience. The ICDS applications process a member's static profile data, recent entertainment selections, travel activities, purchasing trends and other relevant data tracked over time in order to present content selections based on known interests and preferences. When John selects a category, the network further prioritizes content based on John's profile data as processed by the ICDS applications. Therefore, the Network presents John a unique personalized experience and presents him with content specifically tailored to the combination of his interests, preferences, and time/location constraints. The Network becomes a virtual information host, guiding and directing John to an experience that is most efficient and rewarding for John. As John continues to interact with the ICDS, the Network learns John's personality instantiated in time thereby enabling delivery of new, fresh and personally relevant content experience.

As already described above, the ICDS processes member information that is collected using one or more intelligent content algorithms or programs running on one or more processor-based devices (e.g., servers, etc.), which select or determine the content to be delivered to one or more electronic media outlets at a given location and time. The ICDS algorithms, in processing the member information, consider one or more factors, wherein the factors comprises date, time, location, current known or assumed activity, rate of speed, gender, age, expressed or implied interests, known or assumed travel itineraries, language, holidays (e.g., national, international, religious, personal (e.g., birthdays, anniversaries, etc.)), number of members in a given geographic area, emergency factors (e.g., traffic accident, weather situation, terrorist attack, etc.).

The ICDS algorithms weight each factor depending upon the specific situational combination of content and target audience. As another example of the Network's interaction with John Doe, assume that Starbucks uses the ICDS to sell John coffee. The Network knows that John, a healthcare sales professional, visits hospitals and physicians in a certain location every Monday at 8:00 am. Given the Network's assumption (drawn from population data) that sales professionals are early morning coffee drinkers, the ICDS algorithms may weight time of day (week), location and occupational activity in delivering content to members such as John Doe in promoting coffee sales. If the same Starbucks targets a college student, time of day (week), location and occupational activity (i.e. academic activity) are equally important. A student is most likely to purchase coffee late at night while studying near academic institutions. The weighting scheme remains the same while factor values change.

As another example, BMW may target John Doe as a potential buyer for its new sedan. In this example, time of day and day of week are probably far less important. Rather month or time of year may be critical. John Doe may be more likely to buy a new car upon receiving a tax refund or in the month of his wedding anniversary. In addition, John Doe is more likely to buy a new car if he is older and in a higher income bracket. Accordingly, the ICDS algorithms may weight time of year, age and income bracket in delivering content to members such as John Doe in promoting new vehicle sales.

As already described in detail above, the ICDS of an embodiment comprises an infrastructure for the collection and communication of member information or data, the processing of the information, and the intelligent delivery of content targeted to particular members and/or groups of members based on the collected member information. The ICDS infrastructure of an embodiment includes one or more of satellite-based, web-based, cellular-based electric/satellite linked and driven communication or network infrastructure for the collection of member information and the distribution of the targeted information to the members. The members receive the targeted information in their current setting, regardless of whether they are mobile (e.g., automobile, aircraft, boat, walking, etc.) or stationary (e.g., movie theater, sporting event, elevator ride, drive thru, pharmacy drive thru, restaurant drive thru, etc.).

Under an embodiment, the ICDS may leverage knowledge of a subscriber's position near content delivery endpoints to provide personalized messaging services. These ICDS services provide directed communication with a party though a medium independent of any device under such party's control. This alternative embodiment essentially provides members or third parties access to the ICDS for user initiated and user directed messaging. Under this embodiment, advertising content is replaced with personalized or user initiated content.

As already indicated above, the ICDS infrastructure identifies the location of members and delivers appropriate content to such members at delivery points (or through display media) visible to the members. This capability provides tremendous flexibility in the design and delivery of customized information. As one example, a user designs a marriage proposal message with integrated dialogue, music and photos. The user then provides the message to the ICDS via electronic media with directions to deliver the message to a particular person. The user does not need to rely on a known position or location of the recipient at any given time. However, assume that the user actually wishes the proposal to occur in Yankee stadium. The user will have the option to prioritize a time, location and display medium for delivery of the proposal. But the user may also direct the ICDS to select alternative venues when the primary venue is no longer available. Under the marriage proposal example, the couple plans to attend an interleague matchup between the Yankees and the Mets at Yankee stadium. The user has prioritized Yankee stadium (at the time of such game) as the ideal venue for the proposal. However, developing weather forces a cancellation of the game. Therefore, the couple opts for an off-broadway production. The user may rely on the ICDS network to acknowledge the cancelation of the game and locate new venues for delivery of the proposal. As the couple exits a cab near their new destination, the ICDS locates their position, identifies a display medium (electronic billboard) visible to the couple and delivers the marriage proposal.

The flexibility of the ICDS is nearly endless. For example, the user in the example above specifies a preference for the time, location and display of the proposal but may also authorize alternative venues in the event the first preferred venue fails. In the event the primary venue fails, the user may also impose threshold requirements for alternative venues. Continuing with the example, as the couple approaches their alternative theatre destination, the ICDS locates a small billboard at street level that features advertising for local merchants. The ICDS bypasses this delivery option despite the proximity of the couple due to the fact that the user has restricted delivery to larger (i.e., “larger than life”) display media. When the couple is in direct view of an oversized elevated “larger than life” electronic billboard, the ICDS delivers the proposal message. The user may authorize the ICDS to terminate delivery attempts if no venue presents itself within a twelve hour window from the user's initial order.

Under an alternative embodiment, the user may employ the ICDS infrastructure to deliver emergency data. Assume that a first party is touring downtown Chicago by foot and happens to be carrying a cell phone either with no charge or no coverage due to urban structural interference. A second party needs immediate communication with the first party for communication of a medical emergency. As one example, the first party may have forgotten to take critical medication. The second party may deliver this emergency message to the ICDS whereupon the ICDS infrastructure iteratively identifies location/display pairings (i.e., display media near first party) for delivery of the emergency message. The ICDS continues this process until confirmation that the message has been received.

Under another embodiment, a police authority may adopt the ICDS in support of critical mission endpoints and subscribe the police force officers as members of the ICDS. The ICDS may then be used to deliver critical information to officers in pursuit situations. For example, the ICDS may identify locations of officers throughout a pursuit, continually identify display media currently in view of the pursuing officers and display updated drawings/renderings of a suspect while the pursuit is underway.

The ICDS increases in functionality when delivering content to two way communication media. For example, a critical party to a business transaction may be delayed in a cab due to traffic conditions. Again, assume that this party's mobile device is not currently functional due to lack of power or signal interference. As indicated above, the ICDS provides the great advantage of directed communication with a party though a medium independent of any device under such party's control. The ICDS locates a party and a display medium in the line of sight of such party. Continuing with this example, the ICDS identifies a location/display pairing in the form of a street level billboard in view of the missing party as he sits in traffic. Using the street level billboard, remaining parties to the business transaction may deliver a message to the stranded/missing party. The targeted individual views the street level billboard displaying the message, departs the cab, approaches the display and confirms receipt of the message through touch (or other) confirmation. The ICDS then establishes a point-to-point link allowing all parties to consummate the transaction and allowing the stranded party the ability to authenticate documents remotely with electronic authentication.

The ICDS may be configured under another embodiment to deliver content to a targeted individual and to simultaneously record the receipt of the content. For example, a father may craft a birthday video for his son and use the ICDS to deliver the video card. The father knows that the son will be at Madison Square Garden for an event at a certain time. The father therefore wishes to deliver the content during the event. However, the father also wishes to preserve the moment for the future. The ICDS may additionally locate video recording devices capable of capturing the son's presence and may begin recording the son's receipt of the video card at the same time that the birthday message commences.

As indicated above, the ICDS may be configured under an embodiment to deliver content to a targeted individual through a display medium that allows input from the recipient. Further, the ICDS may be further configured to record the receipt of the content. These additional capabilities greatly extend the functionality of the ICDS. As just one example of an application of these functionalities, an individual may attempt to elude service of process in critical litigation by frequently changing locations. Current service of process methods under such circumstances involve tracking of and physical delivery of documents to the individual. Depending upon jurisdictional requirements for service of process, a potential plaintiff may be able deliver a service of process message to the ICDS (assuming that the potential defendant is a subscriber of ICDS services). The ICDS infrastructure then iteratively identifies location/display pairings for delivery of a message to the potential defendant. The delivered communication may invite an action, e.g. to press an icon to view the actual content of the message. When the icon is pressed, the display medium presents the electronic service of process document. If the display medium is not touch enabled or does not accept any input from third parties, the ICDS may also locate recording devices in the vicinity to record and potentially document/authenticate content delivery (depending on jurisdictional requirements) thereby providing evidence of receipt by the recipient.

Under another embodiment, the ICDS uses a cell phone as proximity sensor, user identifier, and conduit for delivery of the content being displayed/delivered to a designated media device or display device. That is, the ICDS may use a cellular network to deliver content or advertisements to a cell phone which then brokers a connection with the closest display medium appropriate to the targeted member. The content and/or advertisement could be delivered to the medium through the phone. Under an alternative embodiment, an identifier associated with the targeted member could be sent to the phone and then sent to the medium whereby the ICDS may communicate directly with the medium and deliver content to the medium using the identifier. It will be understood by one skilled in the art that the ICDS may use any processor based device to serve (in lieu of the cell phone) as proximity sensor, user identifier, and conduit for delivery of the content being displayed/delivered to a designated media device or display device. Such processor based device may include an OnStar device located in a vehicle.

In the description above, numerous specific details are introduced to provide a thorough understanding of, and enabling description for, embodiments of the data storage and tracking. One skilled in the relevant art, however, will recognize that these embodiments can be practiced without one or more of the specific details, or with other components, systems, etc. In other instances, well-known structures or operations are not shown, or are not described in detail, to avoid obscuring aspects of the disclosed embodiments.

Embodiments described herein include a method for targeted electronic information deployment comprising collecting information of at least one user, the information including personal data and information of a current environment, processing the collected information using one or more factors relating to at least one of the personal data information and the current environment information, the processing including weighting the one or more factors to identify content relevant to an experience of the at least one user, scheduling the identified content for delivery using the one or more weighted factors, and delivering the identified content to one or more dynamic display media, wherein an advertising entity controls the one or more display media, wherein the advertising entity delivers the identified content to the one or more display media in the current environment.

Embodiments described herein comprise measuring a response by the at least one user to the delivered content and using the response to update the collected information.

Embodiments described herein include using one or more of the collected information, the identified content and the response to weight the one or more factors.

The scheduling the identified content for delivery of an embodiment comprises scheduling the content for delivery according to a priority.

The priority of an embodiment comprises a degree of relevance of the identified content to the experience of the at least one user.

The one or more factors of an embodiment comprises location, rate, speed and time of the at least one user.

The time of the at least one user of an embodiment comprises at least one of time of day, day of week, month of year and season.

The one or more factors of an embodiment comprises expressed or implied interests of the at least one user.

The one or more factors of an embodiment comprises known or assumed travel itineraries.

The one or more factors of an embodiment comprises one or more languages of the at least one user.

The one or more factors of an embodiment comprises international, religious and personal holidays.

The personal holidays of an embodiment comprise at least one of birthdays and anniversaries.

The one or more factors of an embodiment comprises at least one of demographic and population data in a geographic area.

The one or more factors of an embodiment comprises emergency conditions including traffic accidents, weather situations and terrorist attacks.

The at least one user of an embodiment comprises at least one of an individual, a group, a regional consumer and a global consumer.

The collecting of an embodiment comprising at least one of receiving and retrieving the information from input sources.

The collecting of an embodiment comprising the at least one user directly providing at least one of the personal data information and the current environmental information.

The providing the at least one of the personal data information and the current environmental information of an embodiment comprises the at least one user specifying parameters governing selection of the one or more display media.

The specifying the parameters of an embodiment includes specifying conditions for the delivering the identified content to the one or more display media in the current environment.

The at least one of the receiving and retrieving of an embodiment occurs in near real time.

The at least one of the receiving and retrieving of an embodiment further comprises the at least one user providing access to the input sources.

The input sources of an embodiment include one or more of cellular phones, personal digital assistants (PDAs), and SIM cards, a registration website, and a profile website.

The input sources of an embodiment include one or more of cable, satellite and fiber optic receivers.

The input sources of an embodiment include one or more of airline and travel websites and airline and travel accounts.

The input sources of an embodiment include financial institutions, business entities, and government entities.

The input sources of an embodiment include one or more of stationary implantable devices of organic materials, non-stationary implantable devices of organic materials, stationary implantable devices of non-organic materials and non-stationary implantable devices of non-organic materials.

The non-organic materials of an embodiment include one or more of footwear, articles of clothing, personal transport devices, wheelchairs, scooters, vehicles, automobiles, airplanes, homes and buildings.

The input sources of an embodiment include cellular technology platforms, network technology platforms, satellite-based platforms, wherein the satellite-based platforms include atmospheric based refractory network systems.

The input sources of an embodiment include one or more of automated transaction machines, wherein the automated transaction machines include one or more of monetary and mass data exchange devices.

The input sources of an embodiment include at least one of the cash and credit purchasing history of the at least one user.

The processing of an embodiment comprises selecting one or more locations for delivery of the content.

The processing of an embodiment comprises using the collected information to predict behavior of the at least one user, the predicted behavior including movement of the at least one user to a location of the one or more locations.

The delivering the identified content to the one or more display media in the current environment of an embodiment includes delivering the identified content at the location.

The one or more locations of an embodiment are stationary.

The one or more locations of an embodiment are non-stationary.

The one or more locations of an embodiment comprise the one or more display media.

The one or more display media of an embodiment comprise at least one electronic device, the at least one electronic device including electronic billboards, cellular phones, PDAs, televisions, and Digital Video Recorders.

The at least one electronic display device of an embodiment is located at least one of in and on one or more of vehicles, shopping carts, media poles, casinos including slot machines, automatic transaction machines, and pedestrian crossroads.

Embodiments described herein include a method for targeted electronic information deployment comprising collecting information of at least one user, the information including personal data and information of a current environment, processing the collected information using one or more factors relating to at least one of the personal data information and the current environment information, the processing including weighting the one or more factors to identify content relevant to an experience of the at least one user, scheduling the identified content for delivery using the one or more weighted factors, delivering the identified content to the one or more dynamic display media, wherein an advertising entity controls the one or more display media, wherein the advertising entity delivers the identified content to the one or more display media in the current environment, and measuring a response by the at least one user to the delivered content and using the response to update the collected information.

Embodiments described herein include a system for delivering media content to target recipients, the system comprising a collecting component aggregating individual data of one or more users, a receiving component receiving data of an environment of the one or more users, a filtering component evaluating the environmental data and the individual data using one or more factors to identify content relevant to an experience of the one or more users, the experience comprising the environmental data and the individual data, the evaluating assigning weights to the one or more factors to prioritize the identified content according to a degree of relevance of the identified content to the experience of the one or more user, and a communications component scheduling delivery of the content using information of the prioritizing, transmitting the content to one or more dynamic display media, wherein an advertising entity controls the one or more display media, wherein the advertising entity delivers the content to the display media in at least one of the environments, and collecting a response to the content, wherein the filtering component iteratively uses information of the response during the evaluating.

The processing system of an embodiment includes at least one processor and at least one memory device or subsystem. The processing system can also include or be coupled to at least one database. The term “processor” as generally used herein refers to any logic processing unit, such as one or more central processing units (CPUs), digital signal processors (DSPs), application-specific integrated circuits (ASIC), etc. The processor and memory can be monolithically integrated onto a single chip, distributed among a number of chips or components of a host system, and/or provided by some combination of algorithms. The methods described herein can be implemented in one or more of software algorithm(s), programs, firmware, hardware, components, circuitry, in any combination.

System components embodying the systems and methods described herein can be located together or in separate locations. Consequently, system components embodying the systems and methods described herein can be components of a single system, multiple systems, and/or geographically separate systems. These components can also be subcomponents or subsystems of a single system, multiple systems, and/or geographically separate systems. These components can be coupled to one or more other components of a host system or a system coupled to the host system.

Communication paths couple the system components and include any medium for communicating or transferring files among the components. The communication paths include wireless connections, wired connections, and hybrid wireless/wired connections. The communication paths also include couplings or connections to networks including local area networks (LANs), metropolitan area networks (MANs), wide area networks (WANs), proprietary networks, interoffice or backend networks, and the Internet. Furthermore, the communication paths include removable fixed mediums like floppy disks, hard disk drives, and CD-ROM disks, as well as flash RAM, Universal Serial Bus (USB) connections, RS-232 connections, telephone lines, buses, and electronic mail messages.

Unless the context clearly requires otherwise, throughout the description, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

The above description of embodiments of the data storage and tracking is not intended to be exhaustive or to limit the systems and methods described to the precise form disclosed. While specific embodiments of, and examples for, the data storage and tracking are described herein for illustrative purposes, various equivalent modifications are possible within the scope of other systems and methods, as those skilled in the relevant art will recognize. The teachings of the data storage and tracking provided herein can be applied to other processing systems and methods, not only for the systems and methods described above.

The elements and acts of the various embodiments described above can be combined to provide further embodiments. These and other changes can be made to the data storage and tracking in light of the above detailed description.

The elements and acts of the various embodiments described above can be combined to provide further embodiments. These and other changes can be made to the embodiments described above in light of the above detailed description.

In general, in the following claims, the terms used should not be construed to limit the embodiments described above to the specific embodiments disclosed in the specification and the claims, but should be construed to include all systems that operate under the claims. Accordingly, the embodiments described above are not limited by the disclosure, but instead the scope is to be determined entirely by the claims.

While certain aspects of the embodiments described above are presented below in certain claim forms, the inventors contemplate the various aspects of the embodiments described above in any number of claim forms. Accordingly, the inventors reserve the right to add additional claims after filing the application to pursue such additional claim forms for other aspects of the embodiments described above.

What is claimed is:

1. A method for targeted electronic information deployment comprising:
collecting information of at least one user, the information including personal data and information of a current environment;
processing the collected information using one or more factors relating to at least one of the personal data information and the current environment information, the processing including weighting the one or more factors to identify content relevant to an experience of the at least one user;
scheduling the identified content for delivery using the one or more weighted factors;
delivering the identified content to one or more dynamic display media, wherein an advertising entity controls the one or more display media, wherein the advertising entity delivers the identified content to the one or more display media in the current environment.

2. The method of claim 1, comprising measuring a response by the at least one user to the delivered content and using the response to update the collected information.

3. The method of claim 2, comprising using one or more of the collected information, the identified content and the response to weight the one or more factors.

4. The method of claim 3, the scheduling the identified content for delivery comprising scheduling the content for delivery according to a priority.

5. The method of claim 4, wherein the priority comprises a degree of relevance of the identified content to the experience of the at least one user.

6. The method of claim 1, wherein the one or more factors comprises location, rate, speed and time of the at least one user.

7. The method of claim 6, wherein the time of the at least one user comprises at least one of time of day, day of week, month of year and season.

8. The method of claim 1, wherein the one or more factors comprises expressed or implied interests of the at least one user.

9. The method of claim 1, wherein the one or more factors comprises known or assumed travel itineraries.

10. The method of claim 1, wherein the one or more factors comprises one or more languages of the at least one user.

11. The method of claim 1, wherein the one or more factors comprises international, religious and personal holidays.

12. The method of claim 11, wherein the personal holidays comprise at least one of birthdays and anniversaries.

13. The method of claim 1, wherein the one or more factors comprises at least one of demographic and population data in a geographic area.

14. The method of claim 1, wherein the one or more factors comprises emergency conditions including traffic accidents, weather situations and terrorist attacks.

15. The method of claim 1, wherein the at least one user comprises at least one of an individual, a group, a regional consumer and a global consumer.

16. The method of claim 1, the collecting comprising at least one of receiving and retrieving the information from input sources.

17. The method of claim 16, the collecting comprising the at least one user directly providing at least one of the personal data information and the current environmental information.

18. The method of claim 17, the providing the at least one of the personal data information and the current environmental information comprising the at least one user specifying parameters governing selection of the one or more display media.

19. The method of claim 18, the specifying the parameters including specifying conditions for the delivering the identified content to the one or more display media in the current environment.

20. The method of claim 16, wherein the at least one of the receiving and retrieving occurs in near real time.

21. The method of claim 16, wherein the at least one of the receiving and retrieving further comprises the at least one user providing access to the input sources.

22. The method of claim 21, wherein the input sources include one or more of cellular phones, personal digital assistants (PDAs), and SIM cards, a registration website, and a profile website.

23. The method of claim 21, wherein the input sources include one or more of cable, satellite and fiber optic receivers.

24. The method of claim 21, wherein the input sources include one or more of airline and travel websites and airline and travel accounts.

25. The method of claim 21, wherein the input sources include financial institutions, business entities, and government entities.

26. The method of claim 21, wherein the input sources include one or more of stationary implantable devices of organic materials, non-stationary implantable devices of organic materials, stationary implantable devices of non-organic materials and non-stationary implantable devices of non-organic materials.

27. The method of claim 26, wherein the non-organic materials include one or more of footwear, articles of clothing, personal transport devices, wheelchairs, scooters, vehicles, automobiles, airplanes, homes and buildings.

28. The method of claim 21, wherein the input sources include cellular technology platforms, network technology platforms, satellite-based platforms, wherein the satellite-based platforms include atmospheric based refractory network systems.

29. The method of claim 21, wherein the input sources include one or more of automated transaction machines, wherein the automated transaction machines include one or more of monetary and mass data exchange devices.

30. The method of claim 21, wherein the input sources include at least one of the cash and credit purchasing history of the at least one user.

31. The method of claim 1, the processing further comprising selecting one or more locations for delivery of the content.

32. The method of claim 31, the processing comprising using the collected information to predict behavior of the at least one user, the predicted behavior including movement of the at least one user to a location of the one or more locations.

33. The method of claim 32, the delivering the identified content to the one or more display media in the current environment including delivering the identified content at the location.

34. The method of claim 31, wherein the one or more locations are stationary.

35. The method of claim 31, wherein the one or more locations are non-stationary.

36. The method of claim 31, wherein the one or more locations comprise the one or more display media.

37. The method of claim 36, wherein the one or more display media comprise at least one electronic device, the at least one electronic device including electronic billboards, cellular phones, PDAs, televisions, and Digital Video Recorders.

38. The method of claim 37, wherein the at least one electronic display device is located at least one of in and on one or more of vehicles, shopping carts, media poles, casinos including slot machines, automatic transaction machines, and pedestrian crossroads.

39. A method for targeted electronic information deployment comprising:
collecting information of at least one user, the information including personal data and information of a current environment;
processing the collected information using one or more factors relating to at least one of the personal data information and the current environment information, the processing including weighting the one or more factors to identify content relevant to an experience of the at least one user;
scheduling the identified content for delivery using the one or more weighted factors;
delivering the identified content to the one or more dynamic display media, wherein an advertising entity controls the one or more display media, wherein the advertising entity delivers the identified content to the one or more display media in the current environment; and
measuring a response by the at least one user to the delivered content and using the response to update the collected information.

40. A system for delivering media content to target recipients, the system comprising:
a collecting component aggregating individual data of one or more users;
a receiving component receiving data of an environment of the one or more users;
a filtering component evaluating the environmental data and the individual data using one or more factors to identify content relevant to an experience of the one or more users, the experience comprising the environmental data and the individual data, the evaluating assigning weights to the one or more factors to prioritize the identified content according to a degree of relevance of the identified content to the experience of the one or more user; and
a communications component scheduling delivery of the content using information of the prioritizing, transmitting the content to one or more dynamic display media, wherein an advertising entity controls the one or more display media, wherein the advertising entity delivers the content to the display media in at least one of the environments, and collecting a response to the content, wherein the filtering component iteratively uses information of the response during the evaluating.
